(19) United States
(12) Patent Application Publication
(10) Pub. No.: US 2026/0236394 A1
(43) Pub. Date: Aug. 13, 2026

(54) INLINE AND OUT-OF-BAND ADDRESS TRANSLATION OF MULTIPLE VIRTUAL CHANNELS

(71) Applicant: QUALCOMM Incorporated, San Diego, CA (US)

(72) Inventors: Ravikiran KAIDALA LAKSHMAN, Fremont, CA (US); Ramacharan SUNDARARAMAN, San Jose, CA (US)

(21) Appl. No.: 19/050,812

(22) Filed: Feb. 11, 2025

(51) Int. Cl. G06F 12/02

(52) U.S. Cl. CPC G06F 12/0292; G06F 2212/7201

(57) ABSTRACT

Aspects relate to mechanisms for inline and out-of-band address translation for multiple virtual channels of a PCIe system. A root complex of the PCIe system includes one or more root ports configured to receive a plurality of packets from one or more PCIe endpoints. Each packet is associated with a respective virtual channel of a plurality of virtual channels and each virtual channel includes either ordered traffic or unordered traffic. The root ports are configured to forward a first set of packets associated with unordered traffic to a first memory management unit (MMU) in a first traffic stream to perform inline address translation. The root ports are further configured to forward a second set of packets associated with ordered traffic to a second MMU in a second traffic stream to perform out-of-band address translation.

### TECHNICAL FIELD

The technology discussed below relates generally to data communication interfaces, and more particularly, to address translation on data communication interfaces.

### INTRODUCTION

High-speed data communication interfaces are frequently used between circuits and components of mobile wireless devices and other complex systems. For example, certain devices may include processing, communications, storage, and/or display devices that interact with one another through one or more high-speed interfaces. Some of these devices, including synchronous dynamic random-access memory (SDRAM), may be capable of providing or consuming data and control information at processor clock rates. Other devices, e.g., display controllers, may use variable amounts of data at relatively low video refresh rates.

The peripheral component interconnect express (PCIe) standard is an example of a high-speed data communication interface that supports a high-speed link capable of transmitting data at multiple gigabits per second. PCIe provides lower latency and higher data transfer rates compared to parallel buses. PCIe is specified for communication between a wide range of different devices. Typically, one device, e.g., a processor or hub, acts as a host, that communicates with multiple devices, referred to as endpoints, through PCIe links. The peripheral devices or components may include graphics adapter cards, network interface cards (NICs), storage accelerator devices, mass storage devices, Input/Output interfaces, and other high-performance peripherals.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one example, an apparatus at a root complex is provided. The apparatus includes one or more root ports coupled to one or more endpoints. The one or more root ports are configured to receive a plurality of packets from the one or more endpoints, in which each of the plurality of packets is associated with a respective virtual channel of a plurality of virtual channels, and each of the plurality of virtual channels includes either ordered traffic or unordered traffic. The apparatus further includes a first memory management unit coupled to the one or more root ports and configured to perform inline address translation for a first set of packets of the plurality of packets associated with the unordered traffic in a first traffic stream, and a second memory management unit coupled to the one or more root ports and configured to perform out-of-band address translation for a second set of packets of the plurality of packets associated with the ordered traffic in a second traffic stream.

Another example provides a method of address translation at a root complex. The method includes receiving a plurality of packets from one or more endpoints, in which each of the plurality of packets is associated with a respective virtual channel of a plurality of virtual channels, and each of the plurality of virtual channels includes either ordered traffic or unordered traffic. The method further includes performing inline address translation for a first set of packets of the plurality of packets associated with the unordered traffic in a first traffic stream, and performing out-of-band address translation for a second set of packets of the plurality of packets associated with the ordered traffic in a second traffic stream.

Another example provides an apparatus including means for receiving a plurality of packets from one or more endpoints, in which each of the plurality of packets is associated with a respective virtual channel of a plurality of virtual channels, and each of the plurality of virtual channels includes either ordered traffic or unordered traffic. The apparatus further includes means for performing inline address translation for a first set of packets of the plurality of packets associated with the unordered traffic in a first traffic stream, and means for performing out-of-band address translation for a second set of packets of the plurality of packets associated with the ordered traffic in a second traffic stream.

These and other aspects will become more fully understood upon a review of the detailed description, which follows. Other aspects, features, and examples will become apparent to those of ordinary skill in the art upon reviewing the following description of specific exemplary aspects in conjunction with the accompanying figures. While features may be discussed relative to certain examples and figures below, all examples can include one or more of the features discussed herein. In other words, while one or more examples may be discussed as having certain features, one or more of such features may also be used in accordance with the various examples discussed herein. Similarly, while examples may be discussed below as device, system, or method examples, it should be understood that such examples can be implemented in various devices, systems, and methods.

### BRIEF DESCRIPTION OF THE DRAWINGS

FIG. 1 is a diagram depicting a computing architecture using PCIe interfaces according to some aspects.

FIG. 2 is a diagram depicting an exemplary PCIe system according to some aspects.

FIG. 3 is a diagram depicting an exemplary PCIe topology including virtual channels according to some aspects.

FIG. 4 is a diagram depicting routing of traffic across a PCIe system according to some aspects.

FIG. 5 is a diagram depicting inline and out-of-band address translation for multiple virtual channels of a PCIe system according to some aspects.

FIG. 6 is a flow chart illustrating an exemplary process for inline and out-of-band address translation for multiple virtual channels according to some aspects.

FIG. 7 is a flow chart illustrating another exemplary process for inline and out-of-band address translation for multiple virtual channels according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the invention will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, firmware, or any combination thereof. Whether such elements are implemented as hardware or software depends upon the particular application and design constraints imposed on the overall system.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component-based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for the implementation and practice of described examples. It is intended that innovations described herein may be practiced in a wide variety of devices, chip-level components, systems, distributed arrangements, end-user devices, etc., of varying sizes, shapes, and constitution.

In a PCIe system, a connection between any two PCIe devices (e.g., a root complex (RC) and an endpoint (EP)) is referred to as a PCIe link. A PCIe link is a point-to-point interconnect that supports both internal and external connectivity either across a cable assembly or at the printed circuit board (PCB) level. Connections may be made chip-to-chip with no connectors, through an expansion card interface with a board and a connector, or on a backplane with multiple boards and connectors. The RC is coupled to a processor (e.g., a central processing unit (CPU)) of an apparatus (e.g., wireless communication device, tablet, personal computer, or other computing system) and system memory. The RC further includes one or more root ports (RPs), each coupled to a respective EP directly or to one or more EPs via one or more PCIe switches.

Each PCIe link can support multiple virtual channels to carry different types of traffic over different logical data paths. For example, one virtual channel may carry unordered traffic (unordered I/O (UIO) traffic), whereas another virtual channel may carry ordered traffic (non-UIO traffic). Each virtual channel may utilize a respective virtual address. The RC translates the virtual addresses of inbound traffic (e.g., UIO and non-UIO traffic) to physical addresses for routing of that traffic. For example, the RC may include a system memory management unit (MMU) inline with the inbound traffic stream from the root ports configured to translate virtual addresses (VAs) to physical addresses (PAs). However, inline address translation for both UIO and non-UIO traffic may result in increased latency and reduced throughput due to bottlenecks at the MMU. In addition, inline address translation for both UIO and non-UIO traffic may impact the bandwidth efficiency of the RC.

To decrease latency and increase the throughput and bandwidth efficiency, various aspects are related to mechanisms for performing both inline address translation and out-of-band address translation for multiple virtual channels. For example, out-of-band address translation may be implemented at the root ports for non-UIO traffic, while maintaining inline address translation for UIO traffic. Out-of-band address translation may use a separate out-of-band MMU to perform address translation of non-UIO traffic prior to the root port routing the non-UIO traffic.

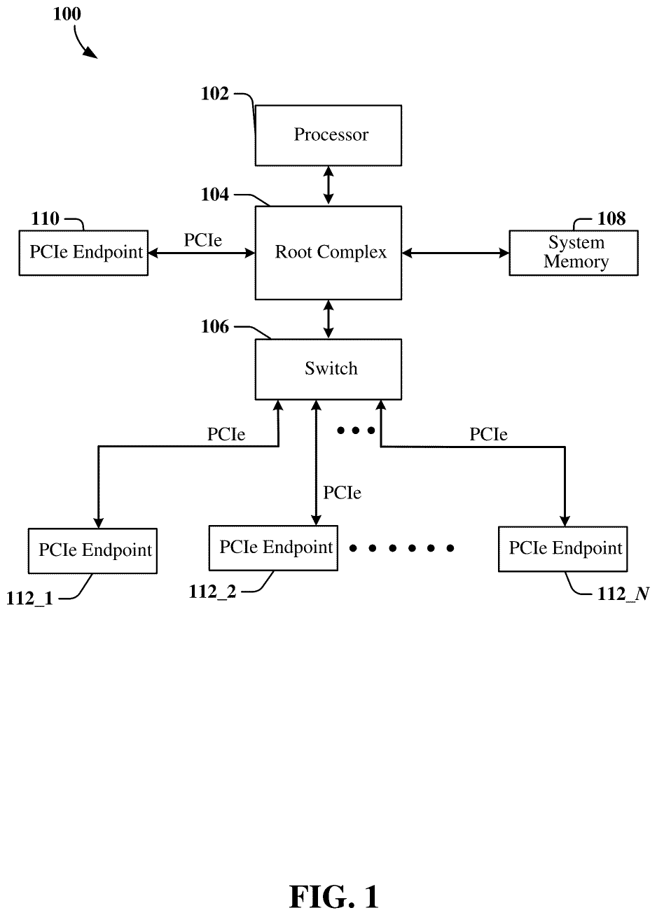

FIG. 1 is a block diagram of an example computing architecture of a computing device using PCIe interfaces according to some aspects. The computing architecture 100 operates using multiple high-speed PCIe interface serial links. A PCIe interface may be characterized as an apparatus including a point-to-point topology, where separate serial links connect each device to a host, which is referred to as a root complex 104 (RC). In the computing architecture 100, the root complex 104 couples a processor 102 (e.g., central processing unit (CPU)) to memory devices, e.g., the system memory 108 (e.g., DDR or SDRAM), and a PCIe switch fabric including one or more PCIe devices (e.g., PCIe switch circuit(s) 106 and PCIe endpoint devices (EPs)). In some instances, the PCIe switch circuit 106 includes cascaded switch devices. One or more PCIe endpoint devices 110 (EP) may be coupled directly to the root complex 104, while other PCIe endpoint devices 112-1, 112-2 . . . 112-N may be coupled to the root complex 104 through the PCIe switch circuit 106. The processor 102 may be referred to herein as an upstream device of the RC 104, whereas the system memory 108, other EPs 110, and PCIe switches 106 may be referred to herein as downstream devices of the RC 104.

The root complex 104 may be coupled to the processor 102 using a proprietary local bus interface or a standards-defined local bus interface. The root complex 104 may control configuration and data transactions through the PCIe interfaces and may generate transaction requests for the processor 102. The root complex 104 may further maintain a master copy of a Type 1 configuration table that defines the host memory space (e.g., memory space in the system memory 108) that is accessible from each endpoint device. In some examples, the root complex 104 is implemented in the same Integrated Circuit (IC) device that includes the processor 102. The root complex 104 supports multiple PCIe ports (e.g., root ports (RPs), not specifically shown in FIG. 1).

The root complex 104 may control communication between the processor 102 and other PCIe endpoint devices 110, 112_1, 112_2 . . . 112_N. The PCIe interface may support full-duplex communication between any two endpoints, with no inherent limitation on concurrent access across multiple endpoints. Data packets may carry information through any PCIe link. In a multi-lane PCIe link, packet data may be striped across multiple lanes. The number of lanes in the multi-lane link may be negotiated during device initialization and may be different for different endpoints.

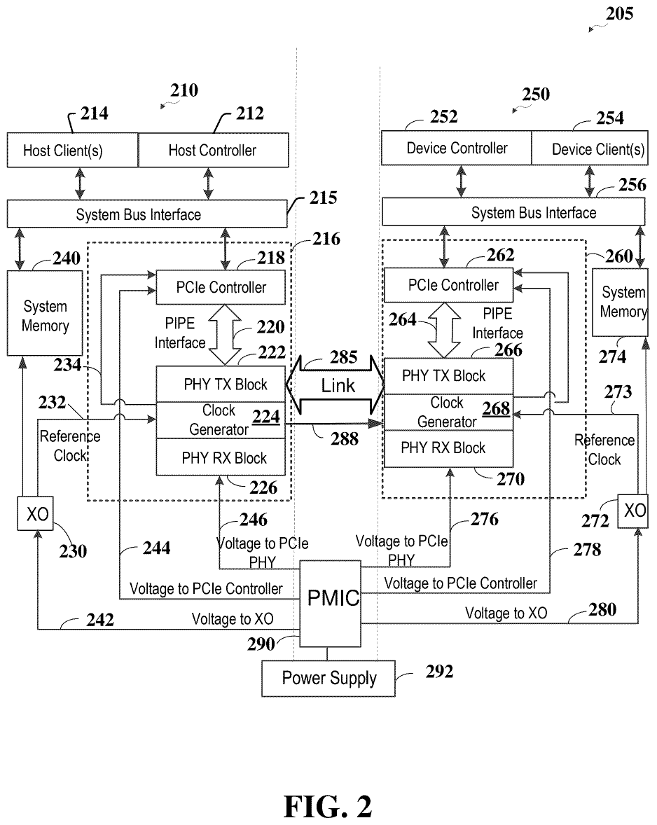

FIG. 2 is a block diagram of an exemplary PCIe system according to some aspects. The system 205 includes a host system 210 and an endpoint device system 250. The host system 210 may be integrated on a first chip (e.g., system on a chip or SoC), and the endpoint device system 250 may be integrated on a second chip. Alternatively, the host system, for example a RC, and/or endpoint device (EP) system may be integrated in first and second packages, e.g., SiP, first and second system boards with multiple chips, or in other hardware or any combination. In this example, the host system 210 and the endpoint device system 250 are coupled by a PCIe link 285.

The host system 210 includes one or more host clients 214. Each of the one or more host clients 214 may be implemented on a processor executing software that performs the functions of the host clients 214 discussed herein. For the example of more than one host client, the host clients may be implemented on the same processor or different processors. The host system 210 also includes a host controller 212, which may perform root complex functions. The host controller 212 may be implemented on a processor executing software that performs the functions of the host controller 212 discussed herein.

The host system 210 includes a PCIe interface circuit 216, a system bus interface 215, and a host system memory 240. The system bus interface 215 may interface the one or more host clients 214 with the host controller 212, and interface each of the one or more host clients 214 and the host controller 212 with the PCIe interface circuit 216 and the host system memory 240. The PCIe interface circuit 216 provides the host system 210 with an interface to the PCIe link 285 and may correspond, for example, to a root port of a root complex. In this regard, the PCIe interface circuit 216 is configured to transmit data (e.g., from the host clients 214) to the endpoint device system 250 over the PCIe link 285 and receive data from the endpoint device system 250 via the PCIe link 285. The PCIe interface circuit 216 includes a PCIe controller 218, a physical interface for PCI Express (PIPE) interface 220, a physical (PHY) transmit (TX) block 222, a clock generator 224, and a PHY receive (RX) block 226. The PIPE interface 220 provides a parallel interface between the PCIe controller 218 and the PHY TX block 222 and the PHY RX block 226. The PCIe controller 218 (which may be implemented in hardware) may be configured to perform transaction layer, data link layer, and control flow functions specified in the PCIe specification, as discussed further below.

The host system 210 also includes an oscillator (e.g., crystal oscillator or “XO”) 230 configured to generate a reference clock signal 232. The reference clock signal 232 may have a frequency of 19.2 MHz in one example, but is not limited to such frequency. The reference clock signal 232 is input to the clock generator 224 which generates multiple clock signals based on the reference clock signal 232. In this regard, the clock generator 224 may include a phase locked loop (PLL) or multiple PLLs, in which each PLL generates a respective one of the multiple clock signals by multiplying up the frequency of the reference clock signal 232.

The endpoint device system 250 includes one or more device clients 254. Each device client 254 may be implemented on a processor executing software that performs the functions of the device client 254 discussed herein. For the example of more than one device client 254, the device clients 254 may be implemented on the same processor or different processors. The endpoint device system 250 also includes a device controller 252. The device controller 252 may be configured to receive bandwidth request(s) from one or more device clients, and determine whether to change the number of active lanes or to change the link speed based on bandwidth requests. The device controller 252 may be implemented on a processor executing software that performs the functions of the device controller.

The endpoint device system 250 includes a PCIe interface circuit 260, a system bus interface 256, and endpoint system memory 274. The system bus interface 256 may interface the one or more device clients 254 with the device controller 252, and interface each of the one or more device clients 254 and device controllers 252 with the PCIe interface circuit 260 and the endpoint system memory 274. The PCIe interface circuit 260 provides the endpoint device system 250 with an interface to the PCIe link 285. In this regard, the PCIe interface circuit 260 is configured to transmit data (e.g., from the device client 254) to the host system 210 (also referred to as the host device) over the PCIe link 285 and receive data from the host system 210 via the PCIe link 285. The PCIe interface circuit 260 includes a PCIe controller 262, a PIPE interface 264, a PHY TX block 266, a PHY RX block 270, and a clock generator 268. The PIPE interface 264 provides a parallel interface between the PCIe controller 262 and the PHY TX block 266 and the PHY RX block 270. The PCIe controller 262 (which may be implemented in hardware) may be configured to perform transaction layer, data link layer and control flow functions.

The host system memory 240 and the endpoint system memory 274 at the endpoint may be configured to contain registers for the configuration and status of each lane of the PCIe link 285 and for the link itself. In an example, the host system memory 240 may include one or more latency tolerance registers configured to maintain latency tolerance data for each of the plurality of endpoints (e.g., endpoint device systems).

The endpoint device system 250 also includes an oscillator (e.g., crystal oscillator) 272 configured to generate a stable reference clock signal 273 for the endpoint system memory 274. In the example in FIG. 2, the clock generator 224 at the host system 210 is configured to generate a stable reference clock signal 273, which is forwarded to the endpoint device system 250 via a differential clock line 288 by the PHY RX block 226. At the endpoint device system 250, the PHY RX block 270 receives the EP reference clock signal on the differential clock line 288, and forwards the EP reference clock signal to the clock generator 268. The EP reference clock signal may have a frequency of 100 MHz, but is not limited to such frequency. The clock generator 268 is configured to generate multiple clock signals based on the EP reference clock signal from the differential clock line 288, as discussed further below. In this regard, the clock generator 268 may include multiple PLLs, in which each PLL generates a respective one of the multiple clock signals by multiplying up the frequency of the EP reference clock signal.

The system 205 also includes a power management integrated circuit (PMIC) 290 coupled to a power supply 292 e.g., mains voltage, a battery or other power source. The PMIC 290 is configured to convert the voltage of the power supply 292 into multiple supply voltages (e.g., using switch regulators, linear regulators, or any combination thereof). In this example, the PMIC 290 generates voltages 242 for the oscillator 230, voltages 244 for the PCIe controller 218, and voltages 246 for the PHY TX block 222, the PHY RX block 226, and the clock generator 224. The voltages 242, 244 and 246 may be programmable, in which the PMIC 290 is configured to set the voltage levels (corners) of the voltages 242, 244 and 246 according to instructions (e.g., from the host controller 212).

The PMIC 290 also generates a voltage 280 for the oscillator 272, a voltage 278 for the PCIe controller 262, and a voltage 276 for the PHY TX block 266, the PHY RX block 270, and the clock generator 268. The voltages 280, 278 and 276 may be programmable, in which the PMIC 290 is configured to set the voltage levels (corners) of the voltages 280, 278 and 276 according to instructions (e.g., from the device controller 252). The PMIC 290 may be implemented on one or more chips. Although the PMIC 290 is shown as one PMIC in FIG. 2, it is to be appreciated that the PMIC 290 may be implemented by two or more PMICs. For example, the PMIC 290 may include a first PMIC for generating voltages 242, 244 and 246 and a second PMIC for generating voltages 280, 278 and 276. In this example, the first and second PMICs may both be coupled to the same power supply 292 or to different power supplies.

In operation, the PCIe interface circuit 216 on the host system 210 may transmit data from the one or more host clients 214 to the endpoint device system 250 via the PCIe link 285. The data from the one or more host clients 214 may be directed to the PCIe interface circuit 216 according to a PCIe map set up by the host controller 212 during initial configuration, sometimes referred to as Link Initialization, when the host controller negotiates bandwidth for the link. In examples, the host controller negotiates a first bandwidth for the transmit group of the link and negotiates a second bandwidth for the receive group of the link. At the PCIe interface circuit 216, the PCIe controller 218 may perform transaction layer and data link layer functions on the data e.g., packetizing the data, generating error correction codes to be transmitted with the data, etc.

The PCIe controller 218 outputs the processed data to the PHY TX block 222 via the PIPE interface 220. The processed data includes the data from the one or more host clients 214 as well as overhead data (e.g., packet header, error correction code, etc.). In one example, the clock generator 224 may generate a clock 234 for an appropriate data rate or transfer rate based on the reference clock signal 232, and input the clock 234 to the PCIe controller 218 to time operations of the PCIe controller 218. In this example, the PIPE interface 220 may include a 22-bit parallel bus that transfers 22-bits of data to the PHY TX block in parallel for each cycle of the clock 234. At 250 MHz this translates to a transfer rate of approximately 8 GT/s.

The PHY TX block 222 serializes the parallel data from the PCIe controller 218 and drives the PCIe link 285 with the serialized data. In this regard, the PHY TX block 222 may include one or more serializers and one or more drivers. The clock generator 224 may generate a high-frequency clock for the one or more serializers based on the reference clock signal 232.

At the endpoint device system 250, the PHY RX block 270 receives the serialized data via the PCIe link 285, and deserializes the received data into parallel data. In this regard, the PHY RX block 270 may include one or more receivers and one or more deserializers. The clock generator 268 may generate a high-frequency clock for the one or more deserializers based on the EP reference clock signal. The PHY RX block 270 transfers the deserialized data to the PCIe controller 262 via the PIPE interface 264. The PCIe controller 262 may recover the data from the one or more host clients 214 from the deserialized data and forward the recovered data to the one or more device clients 254.

On the endpoint device system 250, the PCIe interface circuit 260 may transmit data from the one or more device clients 254 to the host system memory 240 via the PCIe link 285. In this regard, the PCIe controller 262 at the PCIe interface circuit 260 may perform transaction layer and data link layer functions on the data e.g., packetizing the data, generating error correction codes to be transmitted with the data, etc. The PCIe controller 262 outputs the processed data to the PHY TX block 266 via the PIPE interface 264. The processed data includes the data from the one or more device clients 254 as well as overhead data (e.g., packet header, error correction code, etc.). In one example, the clock generator 268 may generates a clock based on the EP reference clock through a differential clock line 288, and inputs the clock to the PCIe controller 262 to time operations of the PCIe controller 262.

The PHY TX block 266 serializes the parallel data from the PCIe controller 262 and drives the PCIe link 285 with the serialized data. In this regard, the PHY TX block 266 may include one or more serializers and one or more drivers. The clock generator 268 may generate a high-frequency clock for the one or more serializers based on the EP reference clock signal.

At the host system 210, the PHY RX block 226 receives the serialized data via the PCIe link 285, and deserializes the received data into parallel data. In this regard, the PHY RX block 226 may include one or more receivers and one or more deserializers. The clock generator 224 may generate a high-frequency clock for the one or more deserializers based on the reference clock signal 232. The PHY RX block 226 transfers the deserialized data to the PCIe controller 218 via the PIPE interface 220. The PCIe controller 218 may recover the data from the one or more device clients 254 from the deserialized data and forward the recovered data to the one or more host clients 214.

The PMIC 290 supports energy-saving power management features that enables devices, such as the host system 210 or endpoint device system 250, to be put into states in which they draw less power (e.g., low-power states). Typically, a device is put into a low-power state when it is underutilized or inactive. The PMIC 290 may be in communication with a CPU (e.g., processor 102 shown in FIG. 1) to control the power states of the host system 210 and each of the endpoint device systems 250 (e.g., for each of the endpoints and/or switches). The processor 102 shown in FIG. 1 may be configured to perform power management at the highest system level (e.g., product/apparatus (e.g., mobile phone, tablet, etc.) level). For example, the processor 102 may be configured to tune the power management of the product/apparatus based on the actual device requirements and adjust the power usage verses performance.

The PCIe system 205 may be configured to support PCIe virtual channels. PCIe virtual channels create multiple logical data paths over a single physical link (e.g., link 285), thus allowing different types of traffic to flow independently using separate resources. Each virtual channel has an independent flow control mechanism, which ensures efficient and prioritized data transfer.

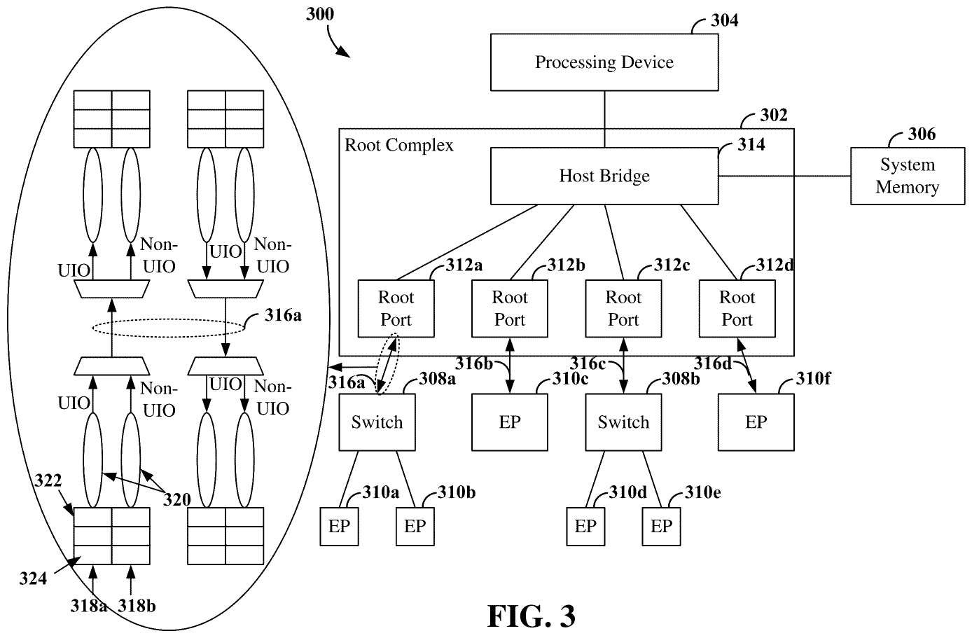

FIG. 3 is a diagram depicting an exemplary PCIe topology including virtual channels according to some aspects. The PCIe topology 300 shown in FIG. 3 illustrates an example of an I/O hierarchy. The PCIe topology 300 includes a root complex 302 that denotes the root of the I/O hierarchy that couples a processing device 304 (e.g., central processing unit (CPU)) and memory devices, e.g., system memory 306 (e.g., DDR or SDRAM) to the I/O. The I/O includes a PCIe switch fabric including one or more PCIe devices (e.g., PCIe switch circuits 308a and 308b and PCIe endpoint devices (EPs) 310a-310f). In the example shown in FIG. 3, the PCIe topology 300 is a tree topology in which each PCI device can have at most one upstream port.

In some instances, the PCIe switch circuit(s) 308 includes cascaded switch devices. One or more PCIe EPs (e.g., EPs 310c and 310f) may be coupled directly to the root complex 302, while other PCIe EP devices 310a, 310b, 310d, and 310f may be coupled to the root complex 302 through PCIe switch circuits 308a and 308b. Each EP 310a-310f may be, for example, a requester or a completer of a PCIe transaction. Each PCIe switch 308a and 308b may include, for example, a logical assembly of multiple PCI-PCI bridge devices.

The root complex 302 includes a plurality of root ports (RPs) 312a-312d, each of which corresponds to a PCIe port that maps a hierarchy domain of the PCIe topology 300 through an associated PCI-PCI bridge. Each hierarchy domain may include a single EP or a sub-hierarchy including one or more switch components and EPs. For example, the hierarchy domain of root port 312a includes switch 308a and EPs 310a and 310b, the hierarchy domain of root port 312b includes EP 310c, the hierarchy domain of root port 312c includes switch 308b and EPs 310d and 310e, and the hierarchy domain of root port 312d includes EP 310f. The root ports 312a-312d form a part of the PCIe switch fabric, such that each root port 312a-312d is configured to couple the PCIe devices (e.g., switches and EPs) in its respective hierarchy domain to the root complex 302 via respective physical links 316a-316d (e.g., PCIe links). The root complex 302 further includes a host bridge 314 including an interconnect fabric that connects the processing device 304 (e.g., host CPU) and system memory 306 to the respective hierarchy domains of the PCIe topology 300.

Each physical link (e.g., PCIe link 316a) can support multiple virtual channels (e.g., virtual channels 318a and 318b) to carry different types of traffic over respective logical links 320. For example, virtual channel 318a may carry unordered traffic (unordered I/O (UIO) traffic), whereas virtual channel 318b may carry ordered traffic (non-UIO traffic). Each virtual channel 318a and 318b can use separate resources, such as queues and buffers 322, to transmit and receive packets 324 (e.g., Transaction Layer Packets (TLPs) associated with the traffic type.

At the transaction layer, flow control across each of the virtual channels 318a and 318b may be independently managed to implement producer-consumer ordering of the packets 324. Producer-consumer ordering is a mechanism between hardware and software to ensure data consistency. For example, a device (e.g., PCIe EP 310a) may write data to the system memory 306 and post a flag indicating completion of the data write. Other devices (e.g., the CPU 304) may consume the data after the flag is posted. This ensures that the consuming device (e.g., the CPU 304) reads the correct/updated data. Producer-consumer ordering may be enforced across the different flow-control classes, including posted transactions (e.g., memory writes), non-posted transactions (e.g., memory reads), and completion transactions (e.g., responses to non-posted transactions). Transaction ordering rules among the different flow-control classes are designed to avoid deadlocks and prevent producer-consumer problems. For example, the transaction ordering rules may require that a posted transaction cannot pass another posted transaction and non-posted transactions with data cannot pass a posted transaction. However, posted transactions can pass non-posted transactions to avoid deadlocks. Thus, posted transactions push all previous posted transactions and non-posted transactions push all previous posted transactions to maintain the ordering. Otherwise, a flag may be written prior to completion of the write associated with the flag, which may result in a read of outdated data.

For non-UIO traffic (or traditional I/O traffic), producer-consumer ordering is managed by the PCIe fabric (e.g., switches 308a/308b and root complex 302). Thus, with non-UIO traffic, each PCIe device is responsible for implementing the producer-consumer ordering rules. By contrast, for UIO traffic, producer-consumer ordering is managed by the initiator of the traffic. For example, for UIO traffic, an initiator of a write transaction delays write of the corresponding flag until a completion of the write transaction is received by the initiator.

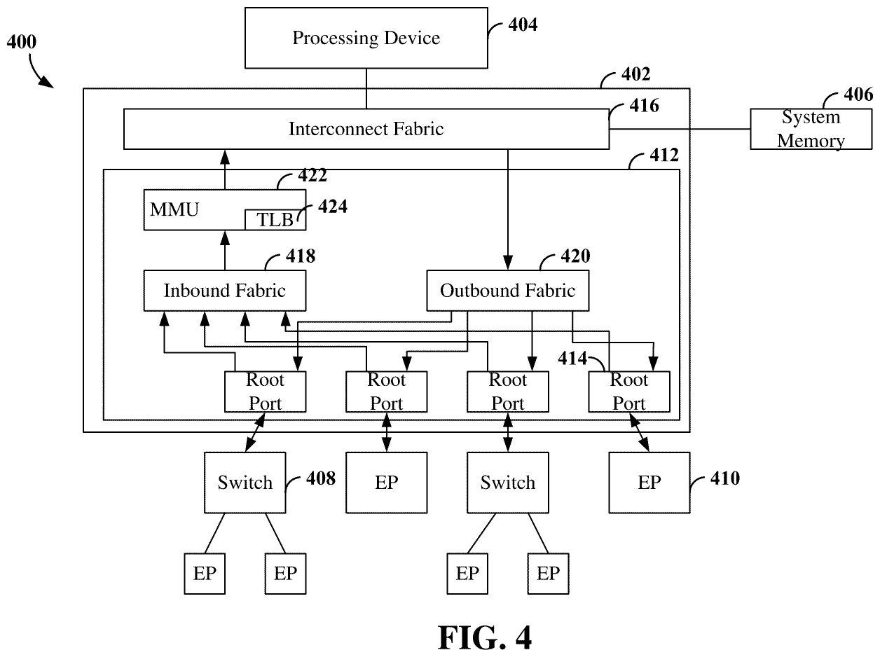

FIG. 4 is a diagram depicting routing of traffic across a PCIe system according to some aspects. The PCIe system 400 includes a root complex 402, a processing device (e.g., host CPU) 404, and a system memory 406. The root complex 402 includes a PCIe subsystem 412 that includes a plurality of root ports 414, each configured to couple respective PCIe devices (e.g., PCIe switches 408 and PCIe EPs 410) to the root complex 402 via respective physical links (e.g., PCIe links).

The root complex 402 includes interconnect fabric (e.g., coherent fabric) 416 configured to transfer traffic between the processing device 404, system memory 406, and PCIe subsystem 412. The interconnect fabric 416 may be composed of point-to-point links that interconnect the coherent fabric 416 to the processing device 404, system memory 406, and PCIe subsystem 412. The root complex 402 further includes inbound fabric 418 configured to aggregate and order (e.g., using the PCIe system ordering rules) all inbound traffic from the root ports 414 and outbound fabric 420 configured to aggregate all outbound traffic to the root ports 414. The inbound fabric 418 and outbound fabric 420 may each be composed of point-to-point links that interconnect the root ports 414 to the coherent traffic 416.

The root complex 402 further includes a system memory management unit (MMU) 422 configured to translate virtual addresses (VAs) to physical addresses (PAs) using, for example, a translation lookaside buffer (TLB) 424. Inbound data paths from the EPs 410 and switches 408 enter the respective root ports 414 and are then forwarded to the MMU 422 for translation. The MMU 422 performs address translation for both UIO traffic and non-UIO traffic to ensure the data is correctly routed to its destination in the PCIe system 400.

In order to meet the PCIe ordering rules, address translation of posted non-UIO traffic (e.g., write transactions) is performed prior to address translation of non-posted non-UIO traffic (e.g., read transactions). Therefore, inline address translation (e.g., using the MMU 422) of both UIO and non-UIO traffic increases the latency of the UIO and non-UIO traffic.

In addition, since the TLB 424 is shared between the two unrelated traffic flows (e.g., UIO and non-UIO), the TLB 424 may be over-subscribed due to the limited cache size of the TLB 424. For example, if the TLB 424 does not include the correct VA-PA address translation, the MMU 422 must then fetch the translation from the system memory 406, which impacts the bandwidth of the PCIe system (e.g., due to the additional transactions involved in fetching the translation). The new address translation retrieved from the system memory 406 is stored in the TLB 424, which may further result in entries in the TLB 424 being removed that correspond to translations in the other traffic flow, leading to TLB thrashing between the traffic flows. The thrashing may decrease the TLB hit rate (e.g., VA-PA match rate), which may increase the latency and reduce performance of the PCIe system 400.

Moreover, the AXI (Advanced eXtensible Interface) protocol does not support virtual channels. As a result, although PCIe can handle multiple logical data paths over a single link, AXI is not able to utilize this feature. Therefore, AXI uses a stall-based flow control on non-UIO traffic that stalls the UIO traffic (and vice-versa). With stall-based flow control, the root ports 414 will not send UIO traffic to the inbound fabric 418 during address translation of non-UIO traffic (and vice-versa).

Various applications such as heterogeneous computing, including artificial intelligence, machine learning, and deep learning require high-performance, low-latency I/O interconnects. To reduce latency and increase performance, out-of-band address translation may be implemented at the root ports 414 for non-UIO traffic, while maintaining inline address translation for UIO traffic.

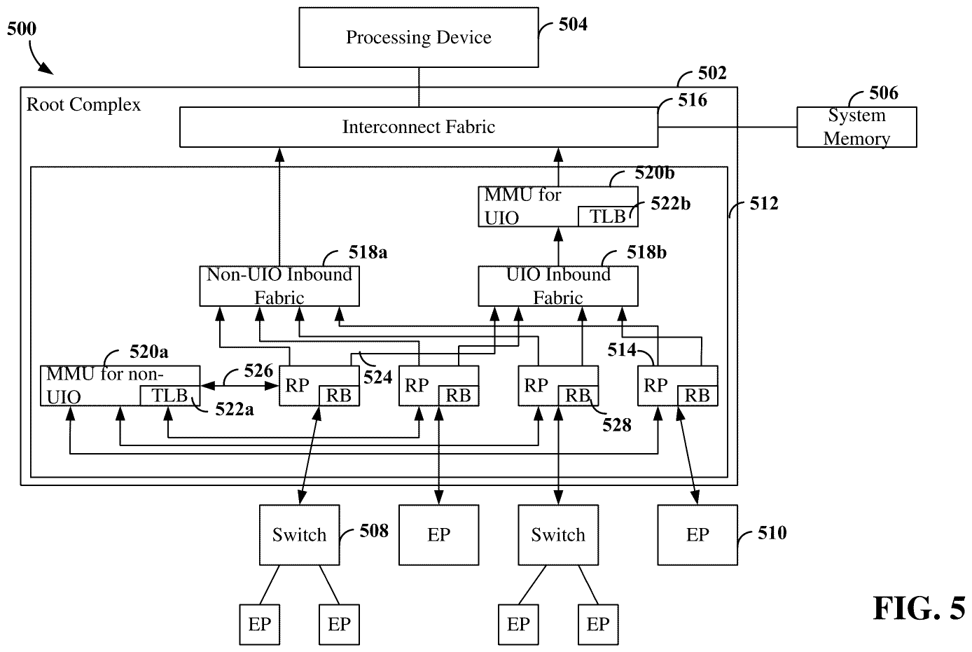

FIG. 5 is a diagram depicting inline and out-of-band address translation for multiple virtual channels of a PCIe system according to some aspects. The PCIe system 500 includes a root complex 502, a processing device (e.g., host CPU) 504, and a system memory 506. The root complex 502 includes a PCIe subsystem 512 that includes a plurality of root ports 514, each configured to couple respective PCIe devices (e.g., PCIe switches 508 and PCIe EPs 510) to the root complex 502 via respective physical links (e.g., PCIe links). The root complex 502 includes interconnect fabric (e.g., coherent fabric) 516 configured to transfer traffic between the processing device 504, system memory 506, and PCIe subsystem 512. The interconnect fabric 516 may be composed of point-to-point links that interconnect the coherent fabric 516 to the processing device 504, system memory 506, and PCIe subsystem 512.

The root complex 502 further includes two different traffic streams. A first traffic stream includes inbound fabric 518a and a second traffic stream includes inbound fabric 518b. Each of the inbound fabric 518a and 518b is configured to aggregate inbound traffic from the root ports 514 for a respective traffic type. For example, inbound fabric 518a may be configured to aggregate and order (e.g., using the PCIe system ordering rules) non-UIO inbound traffic and inbound fabric 518b may be configured to aggregate UIO inbound traffic. The inbound fabric 518a and 518b may each be composed of point-to-point links that interconnect the root ports 514 to the coherent traffic 516.

The root complex 502 further includes a respective MMU 520a and 520b for each traffic stream (e.g., for each of the traffic types). For example, MMU 520a is configured to translate non-UIO virtual addresses (VAs) to physical addresses (PAs) using, for example, a translation lookaside buffer (TLB) 522a. In addition, MMU 520b is configured to translate UIO virtual addresses (VAs) to physical addresses (PAs) using, for example, a separate translation lookaside buffer (TLB) 522b. Each TLB 522a and 522b is configured to maintain address translations for the respective traffic type associated with the corresponding MMU 520a and 520b.

Inbound data paths from the EPs 510 and switches 508 enter the respective root ports 514 and are then parsed at the root ports 514 to separate the UIO traffic 524 (e.g., UIO packets (UIO TLPs)) from the non-UIO traffic 526 (e.g., non-UIO packets (non-UIO TLPs)). The UIO traffic 524 is then forwarded along the second traffic stream from the root ports 514 to the UIO inbound fabric 518b. The inbound fabric 518b then forwards the UIO traffic to the MMU 520b in the second traffic stream for address translation using the TLB 522b. After address translation from respective virtual to physical addresses, the MMU 520b then forwards the UIO traffic to the interconnect fabric 516. For UIO traffic, the responsibility of maintaining the producer-consumer ordering is shifted to the initiator, which eliminates the need for strict ordering rules between posted and non-posted TLPs and allows for using inline address translation from virtual to physical addresses for this type of traffic.

The non-UIO traffic 526 is forwarded along the first traffic stream to the MMU 520a for address translation using the TLB 522a. After address translation from respective virtual to physical addresses, the MMU 520a forwards the non-UIO traffic 526 back to the respective root ports 514, where the non-UIO traffic 526 is re-ordered according to the ordering rules using respective re-order buffers (RBs) 528. The re-ordered non-UIO traffic 526 is then forwarded from the root ports 514 to the non-UIO inbound fabric 518a in the second traffic stream, where the re-ordered non-UIO traffic 526 is then forwarded to the interconnect fabric 516. For ordered IO traffic (e.g., non-UIO traffic), out-of-band address translation is used to ensure the order of transactions is maintained and to mitigate the latency issues resulting from stall-based flow control and TLB thrashing. By enabling two different traffic streams for UIO and non-UIO traffic and using two different inbound fabrics 518a/518b and MMUs 520a/520b, throughput and bandwidth efficiency can be increased. As a result, the MMU bottleneck for different types of traffic may be alleviated, thus ensuring that data flows smoothly and efficiently through the system.

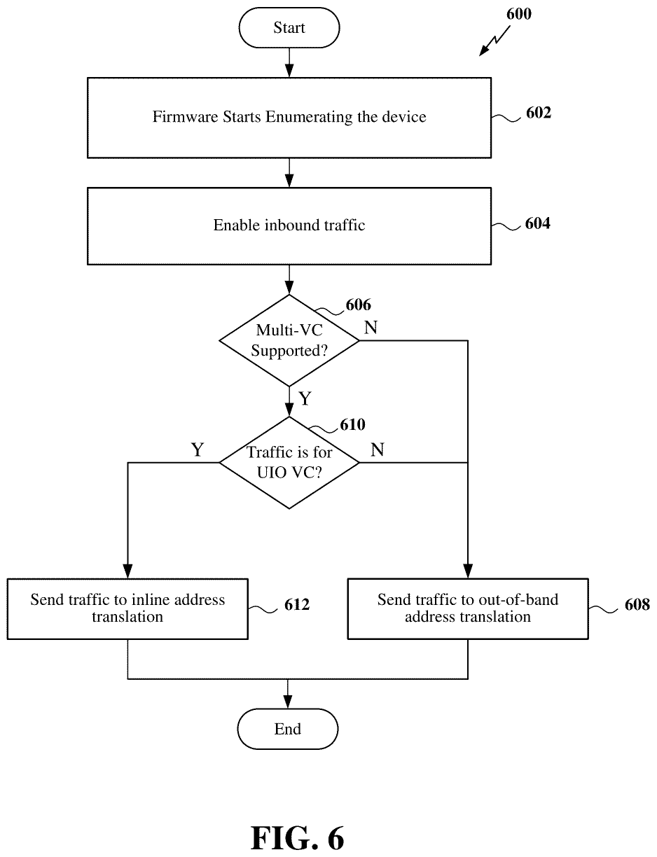

FIG. 6 is a flow chart illustrating an exemplary process 600 for inline and out-of-band address translation according to some aspects. As described below, some or all illustrated features may be omitted in a particular implementation within the scope of the present disclosure, and some illustrated features may not be required for implementation of all embodiments. In some examples, the process 600 may be carried out by the PCIe system 500 shown in FIG. 5. In some examples, the process 600 may be carried out by any suitable apparatus or means for carrying out the functions or algorithm described below.

At block 602, the process begins with the system firmware enumerating the device (e.g., a device including the PCIe system). Enumeration may involve, for example, detection and configuration of the PCIe devices (e.g., switches and EPs) connected to the PCIe system (e.g., the root ports may probe PCIe links to detect connected PCIe devices). In addition, enumeration may include allocation of system memory (host memory) to the PCIe EPs, storage of the Type 1 configuration table that defines the host memory space that is accessible to each EP, and storage of the Type 0 configuration tables in the respective EPs that define the memory space accessible to that EP.

At block 604, the process continues with enabling inbound traffic from the PCIe devices (switches and EPs). At block 606, the process continues with determining whether multiple virtual channels are supported. For example, the process may determine whether both ordered (e.g., non-UIO) and unordered (e.g., UIO) traffic is supported by the device. If the device does not support multiple virtual channels (N branch of block 606), the process continues at block 608 with sending all inbound traffic to the out-of-band address translation traffic stream. For example, if the device only supports ordered (non-UIO) traffic, the non-UIO traffic may be sent to the out-of-band MMU 520a for address translation, as shown in FIG. 5.

If multiple virtual channels are supported (Y branch of block 606), the process continues at block 610 with determining whether the inbound traffic is for the UIO virtual channel (VC) (e.g., the inbound traffic is UIO traffic). If the inbound traffic is UIO traffic (Y branch of block 610), the process continues with sending the UIO traffic to the inline address translation traffic stream. For example, the UIO traffic may be sent to the inline MMU 520b for address translation, as shown in FIG. 5. However, if the inbound traffic is non-UIO traffic (N branch of block 610), the process continues at block 608 with sending the non-UIO traffic to the out-of-band address translation traffic stream.

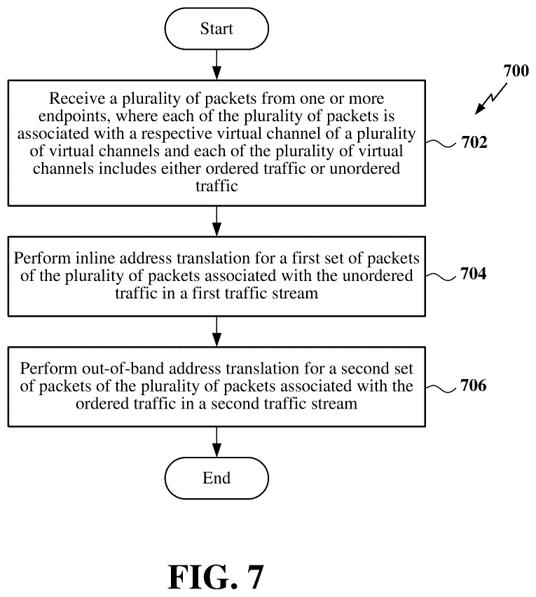

FIG. 7 is a flow chart illustrating another exemplary process 700 for inline and out-of-band address translation for multiple virtual channels according to some aspects. As described below, some or all illustrated features may be omitted in a particular implementation within the scope of the present disclosure, and some illustrated features may not be required for implementation of all embodiments. In some examples, the process 700 may be carried out by the root complex 502 shown in FIG. 5. In some examples, the process 700 may be carried out by any suitable apparatus or means for carrying out the functions or algorithm described below.

At block 702, the process begins with receiving a plurality of packets from one or more endpoints, where each of the plurality of packets is associated with a respective virtual channel of a plurality of virtual channels and each of the plurality of virtual channels includes either ordered traffic or unordered traffic. In some examples, each of the plurality of packets include transaction layer packets. In some examples, the unordered traffic includes unordered input/output (UIO) traffic and the ordered traffic includes non-UIO traffic.

At block 704, the process continues with performing inline address translation for a first set of packets of the plurality of packets associated with the unordered traffic in a first traffic stream. In some examples, the process includes sending the first set of packets from one or more root ports of the root complex to a first memory management unit in the first traffic stream to perform the inline address translation. In some examples, the first memory management unit includes a first translation lookaside buffer configured to store first address translations of virtual addresses to physical addresses. In some examples, the process further includes, in response to performing the inline address translation, forwarding the first set of packets from the memory management unit in the first traffic stream to interconnect fabric of the root complex.

At block 706, the process continues with performing out-of-band address translation for a second set of packets of the plurality of packets associated with the ordered traffic in a second traffic stream. In some examples, the process includes sending the second set of packets from the one or more root ports of the root complex to a second memory management unit in the second traffic stream to perform the out-of-band address translation. In some examples, the second memory management unit includes a second translation lookaside buffer configured to store second address translations of virtual addresses to physical addresses. In some examples, the process further includes, in response to performing the out-of-band address translation at the memory management unit, forwarding the second set of packets from the one or more root ports in the second traffic stream to interconnect fabric of the root complex. In some examples, the process further includes re-ordering the second set of packets at each root port of the one or more root ports following the out-of-band address translation.

In one configuration, the apparatus includes means for receiving a plurality of packets from one or more endpoints, wherein each of the plurality of packets is associated with a respective virtual channel of a plurality of virtual channels, wherein each of the plurality of virtual channels comprises either ordered traffic or unordered traffic; means for performing inline address translation for a first set of packets of the plurality of packets associated with the unordered traffic in a first traffic stream; and means for performing out-of-band address translation for a second set of packets of the plurality of packets associated with the ordered traffic in a second traffic stream. In one aspect, the aforementioned means may be the root complex 502 including the root ports 514 shown in FIG. 5 configured to perform the functions recited by the aforementioned means. In another aspect, the aforementioned means may be a circuit or any apparatus configured to perform the functions recited by the aforementioned means.

Of course, in the above examples, the circuitry included in the root complex is merely provided as an example, and other means for carrying out the described functions may be included within various aspects of the present disclosure, including any other suitable apparatus or means described in any one of the FIGS. 1-5, and utilizing, for example, the processes and/or algorithms described herein in relation to FIGS. 6 and/or 7.

The following provides an overview of aspects of the present disclosure:
Aspect 1: A method of address translation at a root complex, the method comprising: receiving a plurality of packets from one or more endpoints, wherein each of the plurality of packets is associated with a respective virtual channel of a plurality of virtual channels, wherein each of the plurality of virtual channels comprises either ordered traffic or unordered traffic; performing inline address translation for a first set of packets of the plurality of packets associated with the unordered traffic in a first traffic stream; and performing out-of-band address translation for a second set of packets of the plurality of packets associated with the ordered traffic in a second traffic stream.
Aspect 2: The method of aspect 1, further comprising: sending the first set of packets from one or more root ports of the root complex to a first memory management unit in the first traffic stream to perform the inline address translation; and sending the second set of packets from the one or more root ports of the root complex to a second memory management unit in the second traffic stream to perform the out-of-band address translation.
Aspect 3: The method of aspect 2, wherein the first memory management unit comprises a first translation lookaside buffer configured to store first address translations of virtual addresses to physical addresses and the second memory management unit comprises a second translation lookaside buffer configured to store second address translations of virtual addresses to physical addresses.
Aspect 4: The method of aspect 2 or 3, further comprising: in response to performing the inline address translation, forwarding the first set of packets from the first memory management unit in the first traffic stream to interconnect fabric of the root complex.
Aspect 5: The method of any of aspects 2 through 4, further comprising: in response to performing the out-of-band address translation at the second memory management unit, forwarding the second set of packets from the one or more root ports in the second traffic stream to interconnect fabric of the root complex.
Aspect 6: The method of aspect 5, further comprising: re-ordering the second set of packets at each root port of the one or more root ports following the out-of-band address translation.
Aspect 7: The method of any of aspects 1 through 6, wherein each of the plurality of packets comprise transaction layer packets.
Aspect 8: The method of aspect 7, wherein the unordered traffic comprises unordered input/output (UIO) traffic and the ordered traffic comprises non-UIO traffic.
Aspect 9: An apparatus at a root complex comprising one or more root ports coupled to one or more endpoints, wherein the one or more root ports are configured to receive a plurality of packets from the one or more endpoints, wherein each of the plurality of packets is associated with a respective virtual channel of a plurality of virtual channels, wherein each of the plurality of virtual channels comprises either ordered traffic or unordered traffic; a first memory management unit coupled to the one or more root ports and configured to perform inline address translation for a first set of packets of the plurality of packets associated with the unordered traffic in a first traffic stream; and a second memory management unit coupled to the one or more root ports and configured to perform out-of-band address translation for a second set of packets of the plurality of packets associated with the ordered traffic in a second traffic stream.
Aspect 10: The apparatus of aspect 9, wherein the one or more root ports are further configured to: send the first set of packets from the one or more root ports to the first memory management unit in the first traffic stream to perform the inline address translation; and send the second set of packets from the one or more root ports to the second memory management unit in the second traffic stream to perform the out-of-band address translation.
Aspect 11: The apparatus of aspect 9 or 10, wherein the first memory management unit comprises a first translation lookaside buffer configured to store first address translations of virtual addresses to physical addresses and the second memory management unit comprises a second translation lookaside buffer configured to store second address translations of virtual addresses to physical addresses.
Aspect 12: The apparatus of any of aspects 9 through 11, wherein the first memory management unit is further configured to: in response to performing the inline address translation, forward the first set of packets from the first memory management unit in the first traffic stream to interconnect fabric of the root complex.
Aspect 13: The apparatus of any of aspects 9 through 12, wherein the one or more root ports are further configured to: in response to performing the out-of-band address translation at the second memory management unit, forward the second set of packets from the one or more root ports in the second traffic stream to interconnect fabric of the root complex.
Aspect 14: The apparatus of aspect 12, wherein the one or more root ports are further configured to: re-order the second set of packets at each root port of the one or more root ports following the out-of-band address translation.
Aspect 15: The apparatus of any of aspects 9 through 14, wherein each of the plurality of packets comprise transaction layer packets.
Aspect 16: The apparatus of aspect 15, wherein the unordered traffic comprises unordered input/output (UIO) traffic and the ordered traffic comprises non-UIO traffic.
Aspect 17: An apparatus comprising means for performing a method of any of aspects 1 through 8.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-7 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-5 may be configured to perform one or more of the methods, features, or steps described herein. The novel algorithms described herein may also be efficiently implemented in software and/or embedded in hardware.

Any reference to an element herein using a designation e.g., “first,” “second,” and so forth does not generally limit the quantity or order of those elements. Rather, these designations are used herein as a convenient way of distinguishing between two or more elements or instances of an element. Thus, a reference to first and second elements does not mean that only two elements can be employed, or that the first element must precede the second element.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. An apparatus at a root complex, comprising:
one or more root ports coupled to one or more endpoints, wherein the one or more root ports are configured to receive a plurality of packets from the one or more endpoints, wherein each of the plurality of packets is associated with a respective virtual channel of a plurality of virtual channels, wherein each of the plurality of virtual channels comprises either ordered traffic or unordered traffic;
a first memory management unit coupled to the one or more root ports and configured to perform inline address translation for a first set of packets of the plurality of packets associated with the unordered traffic in a first traffic stream; and
a second memory management unit coupled to the one or more root ports and configured to perform out-of-band address translation for a second set of packets of the plurality of packets associated with the ordered traffic in a second traffic stream.

2. The apparatus of claim 1, wherein the one or more root ports are further configured to:
send the first set of packets from the one or more root ports to the first memory management unit in the first traffic stream to perform the inline address translation; and
send the second set of packets from the one or more root ports to the second memory management unit in the second traffic stream to perform the out-of-band address translation.

3. The apparatus of claim 1, wherein the first memory management unit comprises a first translation lookaside buffer configured to store first address translations of virtual addresses to physical addresses and the second memory management unit comprises a second translation lookaside buffer configured to store second address translations of virtual addresses to physical addresses.

4. The apparatus of claim 1, wherein the first memory management unit is further configured to:
in response to performing the inline address translation, forward the first set of packets from the first memory management unit in the first traffic stream to interconnect fabric of the root complex.

5. The apparatus of claim 1, wherein the one or more root ports are further configured to:
in response to performing the out-of-band address translation at the second memory management unit, forward the second set of packets from the one or more root ports in the second traffic stream to interconnect fabric of the root complex.

6. The apparatus of claim 5, wherein the one or more root ports are further configured to:
re-order the second set of packets at each root port of the one or more root ports following the out-of-band address translation.

7. The apparatus of claim 1, wherein each of the plurality of packets comprise transaction layer packets.

8. The apparatus of claim 7, wherein the unordered traffic comprises unordered input/output (UIO) traffic and the ordered traffic comprises non-UIO traffic.

9. A method of address translation at a root complex, the method comprising:
receiving a plurality of packets from one or more endpoints, wherein each of the plurality of packets is associated with a respective virtual channel of a plurality of virtual channels, wherein each of the plurality of virtual channels comprises either ordered traffic or unordered traffic;
performing inline address translation for a first set of packets of the plurality of packets associated with the unordered traffic in a first traffic stream; and
performing out-of-band address translation for a second set of packets of the plurality of packets associated with the ordered traffic in a second traffic stream.

10. The method of claim 9, further comprising:
sending the first set of packets from one or more root ports of the root complex to a first memory management unit in the first traffic stream to perform the inline address translation; and
sending the second set of packets from the one or more root ports of the root complex to a second memory management unit in the second traffic stream to perform the out-of-band address translation.

11. The method of claim 10, wherein the first memory management unit comprises a first translation lookaside buffer configured to store first address translations of virtual addresses to physical addresses and the second memory management unit comprises a second translation lookaside buffer configured to store second address translations of virtual addresses to physical addresses.

12. The method of claim 10, further comprising:
in response to performing the inline address translation, forwarding the first set of packets from the first memory management unit in the first traffic stream to interconnect fabric of the root complex.

13. The method of claim 10, further comprising:
in response to performing the out-of-band address translation at the second memory management unit, forwarding the second set of packets from the one or more root ports in the second traffic stream to interconnect fabric of the root complex.

14. The method of claim 13, further comprising:
re-ordering the second set of packets at each root port of the one or more root ports following the out-of-band address translation.

15. The method of claim 9, wherein each of the plurality of packets comprise transaction layer packets.

16. The method of claim 15, wherein the unordered traffic comprises unordered input/output (UIO) traffic and the ordered traffic comprises non-UIO traffic.

17. An apparatus, comprising:
means for receiving a plurality of packets from one or more endpoints, wherein each of the plurality of packets is associated with a respective virtual channel of a plurality of virtual channels, wherein each of the plurality of virtual channels comprises either ordered traffic or unordered traffic;
means for performing inline address translation for a first set of packets of the plurality of packets associated with the unordered traffic in a first traffic stream; and
means for performing out-of-band address translation for a second set of packets of the plurality of packets associated with the ordered traffic in a second traffic stream.

18. The apparatus of claim 17, further comprising:
means for sending the first set of packets to a first memory management unit in the first traffic stream to perform the inline address translation; and
means for sending the second set of packets to a second memory management unit in the second traffic stream to perform the out-of-band address translation.

19. The apparatus of claim 18, further comprising:
means for forwarding the first set of packets from the first memory management unit in the first traffic stream to interconnect fabric based on the inline address translation.

20. The apparatus of claim 18, further comprising:
means for re-ordering the second set of packets at each root port of one or more root ports based on the out-of-band address translation; and
means for forwarding the second set of packets from the one or more root ports in the second traffic stream to interconnect fabric.
